(19) United States
(12) Patent Application Publication
(10) Pub. No.: US 2014/0103169 A1
(43) Pub. Date: Apr. 17, 2014

(54) Magnetic Clamp

(71) Applicant: Serpent and Dove - applied Magnetics Pty Ltd, Dee Why (AU)

(72) Inventors: Ian Godfrey Heard, Dee Why (AU); Adrian Edward Heard, Dee Why (AU)

(73) Assignee: Serpent and Dove - Applied Magnetics Pty Ltd, Dee Why (AU)

(21) Appl. No.: 14/054,046

(22) Filed: Oct. 15, 2013

(30) Foreign Application Priority Data
Oct. 16, 2012 (AU) 2012904513
Apr. 11, 2013 (AU) 2013204033

(51) Int. Cl. F16M 13/02

(52) U.S. Cl. CPC F16M 13/02
USPC 248/65; 248/206.5; 224/406

(57) ABSTRACT

A magnetic clamp for attaching to a ferromagnetic mounting surface to provide a securement location on the mounting surface is disclosed. The magnetic clamp includes a base member formed of substantially non-ferrous material, wherein the base member is operable to flex to accommodate for changes in curvature or irregularities of the mounting surface and at least one of magnet element arranged on the flexible base member for attaching the base member to the mounting surface. The magnetic clamp further includes a securement means as well as manually actuated release means to remove the magnetic clamp from the mounting surface.

### CROSS-REFERENCE TO RELATED APPLICATIONS

The present application claims priority to Australian Provisional Patent Application No. 2012904513 entitled “Magnetic Clamp” filed Oct. 16, 2012, and Australian Complete Patent Application No. 2013204033 entitled “Magnetic Clamp” filed on Apr. 11, 2013, the disclosures of which are hereby incorporated in their entirety by reference.

The following publication is referred to in the present application and its contents are hereby incorporated by reference in their entirety: Australian Innovation Patent No. 2007100422 A4 titled “Improvements to Magnetic Clamp Release” in the name of Ian Godfrey Heard and filed on May 23, 2007.

### BACKGROUND OF THE INVENTION

1. Field of the Invention

The present invention relates to a magnetic clamp. In a particular form, the present invention relates to a magnetic clamp that provides a securement location when attached to a mounting surface.

2. Description of Related Art

Magnetic clamps are one convenient way to provide a typically temporary securement location when attached to a mounting surface. In one non-limiting example of this type of arrangement, removable magnetic clamps are used to clamp onto the hull of a ship to provide a securement location in form of a lashing point to secure pilot ladders. In other examples, these magnetic clamps may be used to secure floating oil-spill booms, smaller vessels or the like.

Typically these clamps comprise a steel plate with several pot or multi-pole type permanent magnet assemblies of generally rare earth magnets attached to the plate. To remove the magnetic clamp a detachment assembly is incorporated into the clamp that typically involves a lever with plastic or metal rollers at one end which is attached to the steel plate by an over centre pivot axis arrangement and which on actuation functions to lift the steel plate from the mounting surface. Given the securement loads and strength of magnets that are required to provide for the expected tethering loads, these devices have been relatively heavy, weighing in the vicinity of 5 kilograms per unit. As a result, magnetic clamps of this type can be somewhat difficult to deploy at arm's length. In addition, these devices do not properly accommodate for any curvature or irregularities in the hull of a ship again making them difficult to deploy.

There is therefore a need for attachment device that is capable of alleviating one or more of the disadvantages of current attachment devices or to provide consumers with an alternative choice.

### SUMMARY OF THE INVENTION

In a first aspect the present invention accordingly provides a magnetic clamp for attaching to a ferromagnetic mounting surface to provide a securement location on the mounting surface, the magnetic clamp including: a base member formed of substantially non-ferrous material, wherein the base member is operable to flex to accommodate for changes in curvature or irregularities of the mounting surface; at least one of magnet element arranged on the flexible base member for attaching the base member to the mounting surface securement means to provide the securement location; and manually actuated release means to remove the magnetic clamp from the mounting surface.

In another form, the base member is formed from one of, or a combination of, the following materials: nylon; Delrin™; high-density polyethylene; acetal; or aluminium.

In another form, the magnetic clamp includes flexible mounting means to mount the at least one magnet element to the base member.

In another form, the flexible mounting means includes a compressible pad or washer of resilient material.

In another form, the flexible mounting means includes a coil spring.

In another form, the securement means is located on the base member.

In another form, the securement means is for securing a rope or cord to.

In another form, the at least one magnet element is attached to the base member via a blind and threaded hole arrangement in the base member to which a threaded stud is screwed into.

In another form, the at least one magnet element is a manually switchable permanent magnet.

In another form, the manually actuated release means functions to peel away the at least one magnet element from the mounting surface due to the flexibility of the base member.

In another form, the mounting surface is a hull of a ship.

In another form, the magnetic clamp is operable to secure a pilot ladder, oil-spill booms or a vessel to the hull of a ship.

In another form, the at least one magnet element includes three magnets arranged in a triangular configuration across the base member.

### BRIEF DESCRIPTION OF DRAWINGS

Embodiments of the present invention will be discussed with reference to the accompanying drawings wherein:

FIG. 1 is a top view of a magnetic clamp for attaching to a ferromagnetic mounting surface to provide a securement location in accordance with an illustrative embodiment of the present invention;

FIG. 2 is a side view of the magnetic clamp illustrated in FIG. 1;

FIG. 3 is a side view of the magnetic clamp illustrated in FIG. 2 as attached to a curved mounting surface; and

FIG. 4 is a side view of the magnetic clamp illustrated in FIG. 3 depicting the operation of the manually actuated release mechanism to release the magnetic clamp from the mounting surface.

In the following description, like reference characters designate like or corresponding parts throughout the figures.

### DESCRIPTION OF THE INVENTION

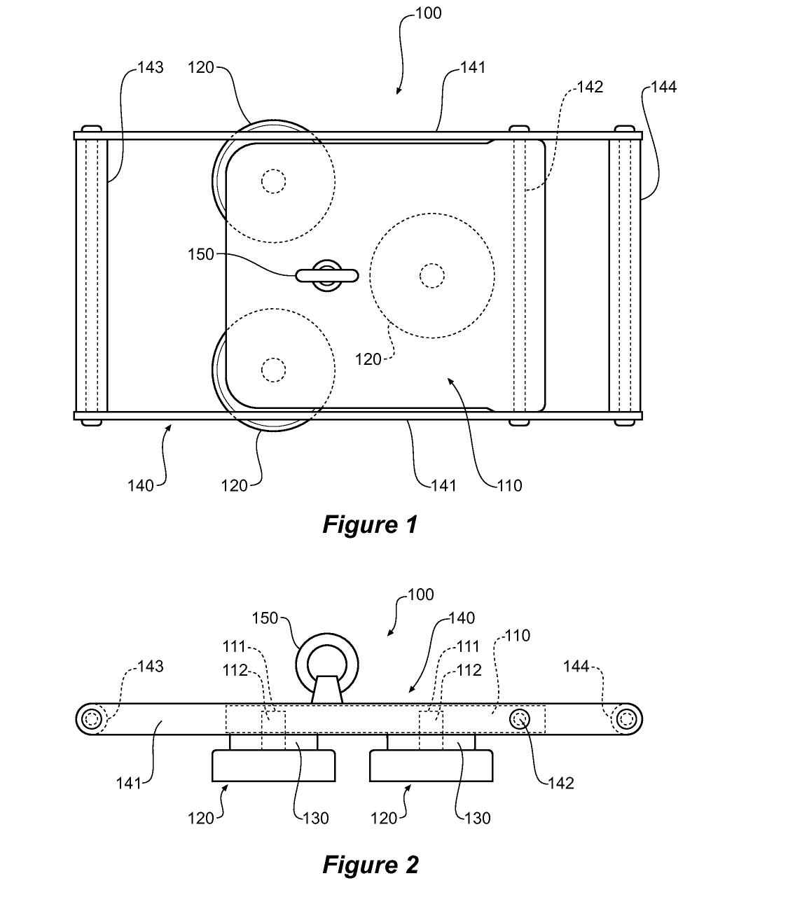

Referring now to FIGS. 1 and 2, there is shown top and side views of a magnetic clamp 100 for attachment to a ferromagnetic mounting surface to provide a securement location. Magnetic clamp includes a base member 110 formed of a non-ferrous flexible material that is able to flex to accommodate for changes of curvature or irregularities of the mounting surface. In this illustrative embodiment, base member 110 is formed of a sheet of suitable plastic material such as high-density polyethylene (HDPE) of thickness 10 mm. In other embodiments, the thickness may range between 6 mm and 20 mm, and more particularly in the ranges of 6-8 mm, 8-10 mm, 10-12 mm, 12-14 mm, 14-16 mm, 16-18 mm and 18-20 mm. In another embodiment, base member 110 is formed from a sheet of aluminium of suitable thickness to allow flexing. In yet other embodiments, base member 110 may be formed from materials including, but not limited to, nylon, acetal or Delrin™ sheet as the case may be. In other embodiments, base member 110 may be formed of multiple layers of differing flexible materials to provide the required flexibility.

While the present invention has been described in relation to a magnetic clamp for a ship's hull it would be readily apparent that the clamp will have many other applications where a securement location is required on a ferromagnetic surface.

Base member 110 further includes in this example three magnet elements 120 arranged across base member 110 in a triangular configuration. In this illustrative embodiment, magnet elements 120 are circular in configuration, ranging in diameter typically between 70 and 90 mm, and having a steel cup that houses a typically neodymium or other rare earth magnet ring or disc. The steel or soft iron cup forms part of the magnetic circuit conducting one pole to the front face of the magnet element 120.

In other embodiments, magnet elements may include other types of permanent magnets including, but not limited to, laminated north/south/north/south etc. magnets of square or rectangular shape or other configurations that would as an example be suitable for a magnetic clamp 100 that is attachable to the hull of a ship and that provides a securement location for rope ladders and the like. In this illustrative embodiment, base member 110 includes securement means in the form of a stainless steel eye 150 rotatably mounted to base member 110 and forming a lashing point to which a rope or cord may be tied. Other types of securement means include, but are not limited to, screw threaded arrangements to receive a bolt or similar or other types of coupling points.

As would be appreciated by those of ordinary skill in the art, the strength, configuration and number of magnets may be varied according to the clamping requirements of magnetic clamp 100. Some example configurations include, but are not limited to, four magnet arrangements arranged in a square or rectangular configuration. In yet other embodiments, multiple smaller magnets may be arranged across base member 110 such as in a part arcuate or circular arrangement. In another embodiment, magnet elements 120 are switchable permanent magnets that are manually switched on by a handle or the like to position internal magnet elements to concentrate magnetic flux at the magnetising surface.

Magnetic clamp 100 in this illustrative embodiment further includes flexible mounting means 130 in form of a compressible washer of suitable resilient material such as compressible rubber or neoprene that allows the orientation of one or more of the magnet elements 120 to vary to accommodate any curvature or irregularities in the ferromagnetic surface such as would be present in relation to the hull of a ship. In another illustrative embodiment, flexible mounting means may include a metallic coil spring. Magnet elements 120 in this embodiment are attached to base member 110 by threaded bolts or studs 112 of HDPE or other plastic material screwed into blind threaded holes 111 formed in base member 110. As would be appreciated by those of ordinary skill in the art, this arrangement reduces the weight as compared to a standard bolt and nut attachment arrangement which may also be an option depending on requirements.

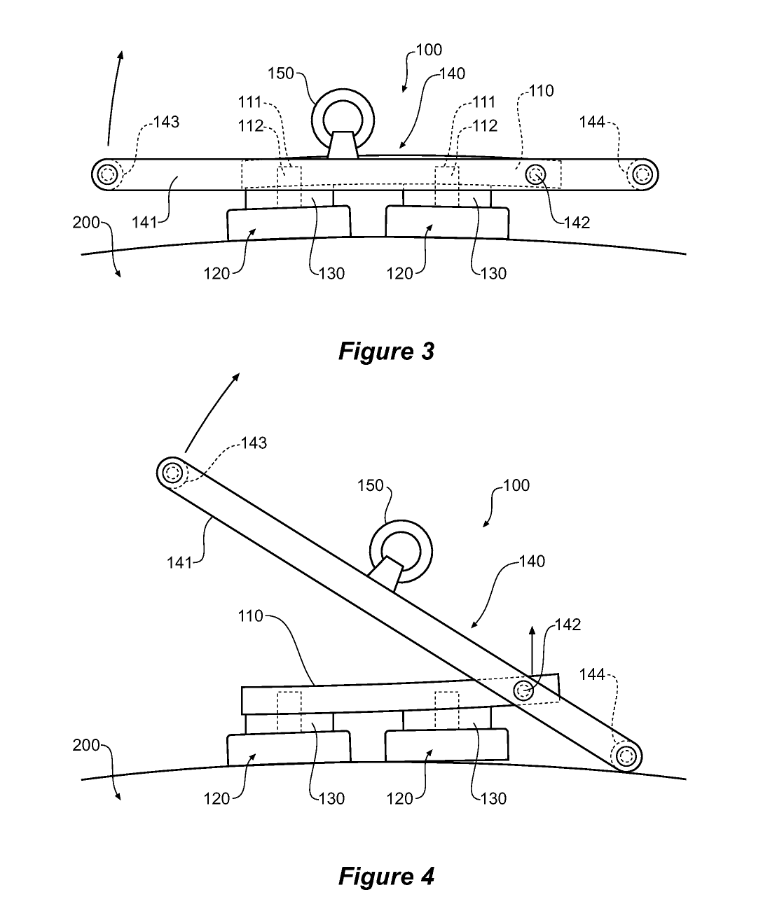

Referring now also to FIGS. 3 and 4 there is shown side views of magnetic clamp 100 attached to a curved mounting surface 200 which shows the flexing of base member 110 to accommodate for the curvature of the mounting surface 200. As would be appreciated by those of ordinary skill in thart, the degree of flexibility of base member 110 may be varied according to the degree of curvature or irregularities expected in the mounting surface 200.

As is apparent from the figures, magnetic clamp 100 further includes manually actuated release means 140 in the form of a lever arrangement consisting of a pair of opposed lever arms 141 extending along the sides of, and pivotably attached to, base member 110 through an axle 142 extending through base member 110 at one end. In another embodiment, instead of axle 142 extending through the entire width of the base member 110, two short axles may be employed each threaded into a respective side of base member 110.

Release means 140 includes a handle 143 located at one end and extending between lever arms 141. In this illustrative embodiment, handle 143 is rotatably attached to lever arms 141 so that the handle 143 will rotate on actuation of release means 140. At the other end of lever arms, is the force imparting region 144 that acts against the surface 200. Force imparting region 144 in this illustrative embodiment includes a roller element extending between the opposed ends of lever arms 141 in a similar manner to handle 143. Roller element functions to roll along surface 200 to reduce the potential for damage and further may be formed of a resilient material to further minimise the risk of damage to a surface.

As shown in FIG. 4 which depicts the operation of release means 140, handle 143 is lifted in the direction as indicated by the arrow causing force imparting region 144 to abut against surface 200. Further lifting of handle 143 results in a release force operating to cause a bending moment and lift base member 110 in the direction as indicated by the arrow due to the reaction force between force imparting region 144 and mounting surface 200. As base member 110 is flexible, this release force may also act to peel away magnet elements 120 from surface 200.

Other manually actuated release means may be used including those described in Australian Innovation Patent No. 2007100422 A4 to Ian Godfrey Heard and filed on 23 May 2007 which is hereby incorporated by reference in its entirety.

The applicant has found that due to the flexible base member 110 being able to flex in accordance with the curvature of the mounting surface then a given magnet size will clamp more effectively as its orientation will conform more readily to any curvature or irregularities in the mounting surface. This conformance is further facilitated by the flexible mounting means for the magnet elements. In addition, by recognising that contrary to prior art arrangements a flexible base member may be used, the weight of the base member may be substantially reduced by using suitable plastics or other non-ferromagnetic materials such as aluminium thereby ensuring that magnetic clamp 100 is easier to deploy on a mounting surface whether it be curved or not. As an example, the embodiment depicted in FIGS. 1-4 has a weight not exceeding 3.3 kg, thereby providing an important manual operability advantage over prior art clamps.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A magnetic clamp for attaching to a ferromagnetic mounting surface to provide a securement location on the mounting surface, the magnetic clamp comprising:
a base member formed of substantially non-ferrous material, wherein the base member is operable to flex to accommodate for changes in curvature or irregularities of the mounting surface;
at least one magnet element arranged on the flexible base member for attaching the base member to the mounting surface;
securement means to provide the securement location; and
manually actuated release means to remove the magnetic clamp from the mounting surface.

2. The magnetic clamp of claim 1, wherein the base member is formed from at least one of the following: nylon; Delrin™; high-density polyethylene; acetal; aluminium, or any combination thereof.

3. The magnetic claim of claim 1, wherein the magnetic clamp includes flexible mounting means to mount the at least one magnet element to the base member.

4. The magnetic clamp of claim 3, wherein the flexible mounting means includes a compressible pad or washer of resilient material.

5. The magnetic clamp of claim 3, wherein the flexible mounting means includes a coil spring.

6. The magnetic clamp of claim 1, wherein the securement means is located on the base member.

7. The magnetic clamp of claim 1, wherein the securement means is configured for securing a rope or cord.

8. The magnetic clamp of claim 1, wherein the at least one magnet element is attached to the base member via a blind and threaded hole arrangement in the base member into which a threaded stud is screwed.

9. The magnetic clamp of claim 1, wherein the at least one magnet element is a manually switchable permanent magnet.

10. The magnetic clamp of claim 1, wherein the manually actuated release means is configured to peel away the at least one magnet element from the mounting surface due to the flexibility of the base member.

11. The magnetic clamp of claim 1, wherein the mounting surface is a hull of a ship.

12. The magnetic clamp of claim 11, wherein the magnetic clamp is operable to secure at least one of the following: a pilot ladder, oil-spill booms, a vessel, or any combination thereof, to the hull of a ship.

13. The magnetic clamp of claim 1, wherein the at least one magnet element includes three magnets arranged in a triangular configuration across the base member.

14. The magnetic claim of claim 2, wherein the magnetic clamp includes flexible mounting means to mount the at least one magnet element to the base member.

15. The magnetic clamp of claim 2, wherein the securement means is located on the base member.

16. The magnetic clamp of claim 3, wherein the securement means is located on the base member.

17. The magnetic clamp of claim 4, wherein the securement means is located on the base member.

18. The magnetic clamp of claim 5, wherein the securement means is located on the base member.

19. The magnetic clamp of claim 2, wherein the at least one magnet element is attached to the base member via a blind and threaded hole arrangement in the base member into which a threaded stud is screwed.

20. The magnetic clamp of claim 2, wherein the at least one magnet element includes three magnets arranged in a triangular configuration across the base member.
